(19) United States
(12) Patent Application Publication
(10) Pub. No.: US 2016/0197651 A1
(43) Pub. Date: Jul. 7, 2016

(54) WIRELESS COMMUNICATION DEVICE AND MOBILE TERMINAL

(71) Applicant: Nobunari Tsukamoto, Osaka (JP)

(72) Inventor: Nobunari Tsukamoto, Osaka (JP)

(73) Assignee: RICOH COMPANY, LTD., Tokyo (JP)

(21) Appl. No.: 14/976,612

(22) Filed: Dec. 21, 2015

(30) Foreign Application Priority Data
Jan. 5, 2015 (JP) 2015-000275

(51) Int. Cl. H04B 5/00; H04W 4/02; H04W 4/00

(52) U.S. Cl. CPC H04B 5/0043; H04B 5/0087; H04W 4/008; H04W 4/026

(57) ABSTRACT

A wireless communication device that communicates wirelessly with other device includes a first antenna, a second antenna, a measurer, and a selector. The first antenna is a loop or loops of coiled wire, and the first antenna is disposed on a substrate so that a rotation axis of the first antenna is orthogonal to the substrate. The second antenna is a loop or loops of coiled wire, and the second antenna is disposed on the substrate so that a rotation axis of the second antenna is parallel to the substrate. The measurer measures signals respectively generated in the first antenna and the second antenna, in accordance with a positional relationship between the other device and the wireless communication device. The selector selects one of the first antenna and the second antenna as an antenna for communicating with the other device, in accordance with amplitude of the measured signals.

### CROSS-REFERENCE TO RELATED APPLICATIONS

This patent application is based on and claims priority pursuant to 35 U.S.C. §119(a) to Japanese Patent Application No. 2015-000275, filed on Jan. 5, 2015, in the Japan Patent Office, the entire disclosure of which is hereby incorporated by reference herein.

### BACKGROUND

1. Technical Field

The present invention relates to a wireless communication device and a mobile terminal.

2. Description of the Related Art

In order to implement a wireless communication function such as near field communication (NFC) in devices such as mobile terminals, a loop antenna that is a loop(s) of coiled wire is often mounted. It is known that the communication range is increased by enlarging the shape of such a loop antenna. In contrast, devices such as mobile terminals have an increasing number of parts and are becoming more and more compact and light-weight, and these mobile terminals only have a limited volume for mounting an antenna. It is thus required to reduce the size and thickness of an antenna to be mounted in such devices.

A loop antenna is easily influenced by a metallic part, and the magnetic field necessary for communication is weakened when a loop antenna is mounted near a metallic part. In the case of mounting a loop antenna in a device, it is necessary to take into consideration the effect of a metallic part mounted in the device. In view of this, a bar-shaped antenna that is wire coiled around a magnetic body (hereinafter referred to as a “bar antenna”) may be mounted as an antenna that is small and less susceptible to the effect of a metallic part.

Alternatively, both a loop antenna and a bar antenna may be mounted, thereby expanding a communicable range by having different rotation axes.

In the case where a device having mounted therein the above-described loop antenna and/or bar antenna performs wireless communication with a reader/writer, the communication quality may deteriorate depending on their positional relationship. For example, in the case where a reader/writer includes a loop antenna, when a device having mounted therein a loop antenna communicates with the reader/writer, there is a position at an end of the loop antenna of the reader/writer where no communication can be performed (hereinafter this position will be referred to as the “null point”), and the communication quality deteriorates at the null point. When the reader/writer communicates with a device having mounted therein a bar antenna, there is a null point near the center of the loop antenna of the reader/writer, and the communication quality deteriorates at the null point.

In the case of mounting both a loop antenna and a bar antenna in a device, electric currents that are generated in the loop antenna and the bar antenna mounted in the device cancel each other out at a position where the electric currents are in opposite directions, and at this position, namely, the null point, the sum of the electric currents becomes zero. The communication quality thus deteriorates at the null point.

### SUMMARY

A wireless communication device that communicates wirelessly with other device includes a first antenna, a second antenna, a measurer, and a selector. The first antenna is a loop or loops of coiled wire, and the first antenna is disposed on a substrate so that a rotation axis of the first antenna is orthogonal to the substrate. The second antenna is a loop or loops of coiled wire, and the second antenna is disposed on the substrate so that a rotation axis of the second antenna is parallel to the substrate. The measurer measures signals respectively generated in the first antenna and the second antenna, in accordance with a positional relationship between the other device and the wireless communication device. The selector selects one of the first antenna and the second antenna as an antenna for communicating with the other device, in accordance with amplitude of the measured signals.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating the configuration of radio-frequency identifier (RFID) tags and a reader/writer in the related art for comparison with an embodiment of the present invention, using two axes, namely, a cross-section and an overhead view;

FIGS. 2A and 2B are diagram illustrating the shape of a loop antenna and a bar antenna, respectively, according to an embodiment of the present invention;

FIGS. 3A and 3B are graphs illustrating electric currents generated in the loop antenna and the bar antenna, respectively, according to the embodiment of the present invention;

FIG. 4 is a graph illustrating an electric current generated in an antenna including the loop antenna and the bar antenna connected to each other, according to the embodiment of the present invention;

FIG. 5 is a diagram illustrating the configuration of an RFID tag according to a first embodiment of the present invention;

FIG. 6 is a diagram illustrating the arrangement of the loop antenna and the bar antenna according to the first embodiment of the present invention;

FIG. 7 is a diagram illustrating the configuration of a detector according to the first embodiment of the present invention;

FIGS. 8A to 8C are diagrams illustrating the amplitude of voltages generated in the individual antennas, and outputs from rectifier circuits according to the embodiment of the present invention;

FIGS. 9A to 9C are diagrams illustrating the amplitude of voltages generated in the individual antennas, and outputs from the rectifier circuits according to the embodiment of the present invention;

FIG. 10 is a diagram illustrating the configuration of a selector according to the embodiment of the present invention;

FIG. 11 is a graph illustrating an electric current generated in the RFID tag according to the embodiment of the present invention;

FIG. 12 is a diagram illustrating the configuration of an RFID tag according to a second embodiment of the present invention;

FIG. 13 is a diagram illustrating the configuration of a switch controller according to the second embodiment of the present invention;

FIG. 14 is a flowchart illustrating the operation of a digital control circuit according to the second embodiment of the present invention;

FIG. 15 is a diagram illustrating the arrangement of a loop antenna and two bar antennas according to a third embodiment of the present invention;

FIG. 16 is a diagram illustrating the configuration of an RFID tag according to the third embodiment of the present invention; and

FIG. 17 is a diagram illustrating the configuration of an RFID tag according to the third embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Hereinafter, an embodiment of the present invention will be described in detail with reference to the drawings. In the embodiment, a radio frequency identifier (RFID) tag will be discussed by way of example as a wireless communication device that wirelessly communicates with another device. Also in the embodiment, a reader/writer that reads/writes data from/to the RFID tag will be discussed by way of example as another device that communicates with the RFID tag.

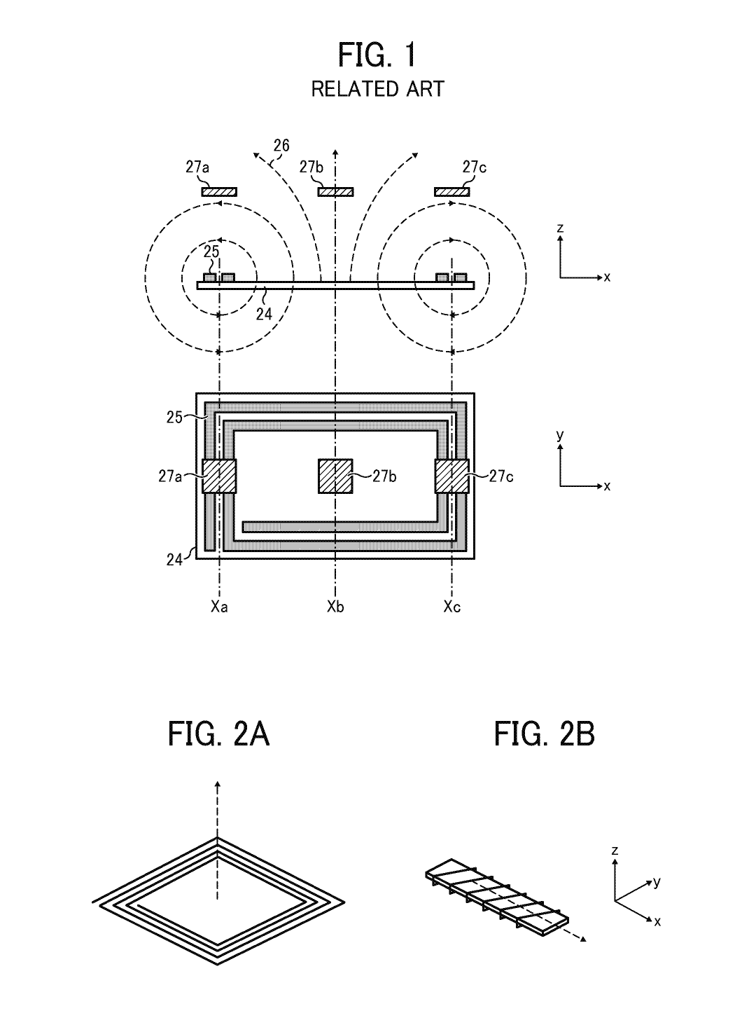

At first, a known configuration will be described prior to the description of the embodiment. FIG. 1 is a diagram illustrating the configuration of RFID tags 27a, 27b, and 27c and a reader/writer 24 of the related art for comparison with the embodiment, using two axes, namely, a cross-section and an overhead view. As illustrated in FIG. 1, an antenna 25 that includes loops of coiled wire, for example, is disposed on a substrate of the reader/writer 24.

In FIG. 1, Xa, Xb, and Xc indicate coordinates in the x-axis direction (hereinafter referred to as “X coordinates”). The reader/writer 24 reads/writes data from/to the RFID tags 27a, 27b, and 27c at the positions Xa, Xb, and Xc, respectively. Hereinafter, the RFID tags 27a, 27b, and 27c may be collectively referred to as the “RFID tag(s) 27”.

Specifically, when the reader/writer 24 causes electric current to flow through the antenna 25, a magnetic field 26 illustrated in FIG. 1 is generated. The RFID tag 27 converts the electric current generated by electromagnetic induction of the magnetic field 26 to a voltage, thereby becoming capable of communicating with the reader/writer 24. The reader/writer 24 reads/writes data from/to a communicable RFID tag 27. That is, the communication quality between the reader/writer 24 and the RFID tag 27 depends on the magnetic field 26 at the position of the RFID tag 27 and the antenna configuration of the RFID tag 27.

FIGS. 2A and 2B are diagrams each illustrating the shape of an antenna that may be mounted in the RFID tag 27. FIG. 2A is a diagram illustrating an antenna that includes loops of coiled wire (hereinafter referred to as a “loop antenna”), and FIG. 2B is a diagram illustrating a bar-shaped antenna that is wire coiled around a magnetic body (hereinafter referred to as a “bar antenna”). As illustrated in FIGS. 2A and 2B, the rotation axis of the loop antenna is orthogonal (z-axis direction) to the substrate on which the antenna is disposed, and the rotation axis of the bar antenna is parallel (x-axis direction) to the substrate on which the antenna is disposed.

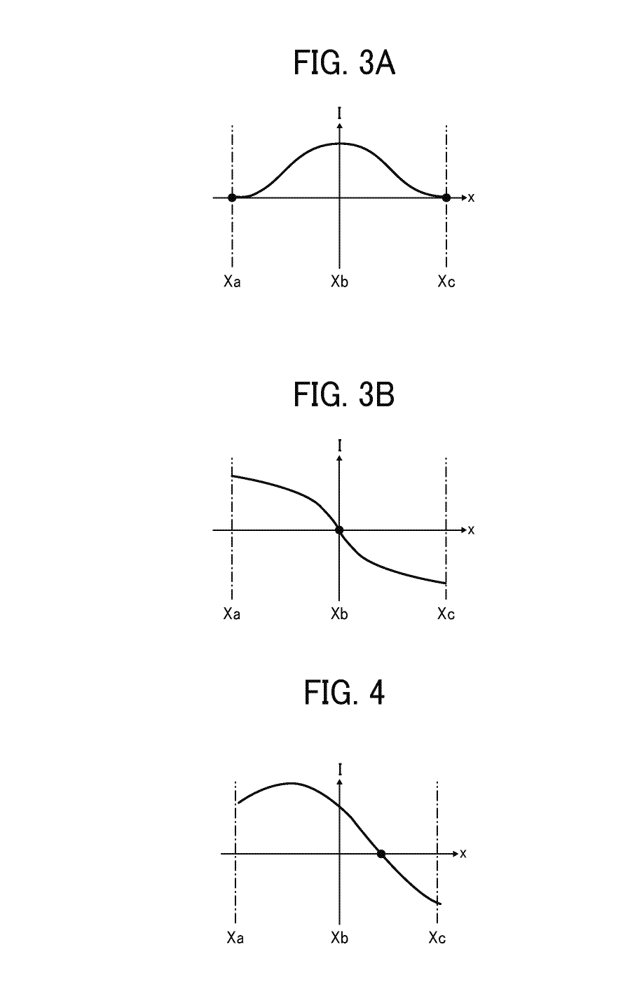

FIGS. 3A and 3B are graphs illustrating electric currents generated by electromagnetic induction of the magnetic field 26 illustrated in FIG. 1, in the loop antenna and the bar antenna illustrated in FIGS. 2A and 2B, respectively. In the graphs illustrated in FIGS. 3A and 3B, the abscissa axis represents an X-coordinate, and the ordinate axis represents an electric current I. Note that Xa, Xb, and Xc illustrated in FIGS. 3A and 3B correspond respectively to Xa, Xb, and Xc illustrated in FIG. 1. In addition, it is assumed that the graphs illustrated in FIGS. 3A and 3B are in the case where a coordinate in the z-axis direction (Z-coordinate) is fixed, that is, the distance between the RFID tag 27 and the reader/writer 24 is constant, and also a coordinate in the y-axis direction (Y-coordinate) is fixed at the center position of the reader/writer 24.

FIG. 3A is a diagram illustrating an electric current generated in the loop antenna illustrated in FIG. 2A. In the case where the RFID tag 27 having mounted therein the loop antenna illustrated in FIG. 2A is positioned at Xb, which is the center of the reader/writer 24, as illustrated in FIG. 1, the direction of the magnetic field 26 is orthogonal to a plane of the loop antenna. Therefore, the magnetic field 26 which exits from the rotation axis becomes maximum when the loop antenna is positioned at Xb. As illustrated in FIG. 3A, the electric current generated in the loop antenna becomes maximum when the RFID tag 27 is positioned at Xb.

In contrast, in the case where the RFID tag 27 having mounted therein the loop antenna is positioned at Xa or Xc, which is an end in the x-axis direction of the reader/writer 24, as illustrated in FIG. 1, the direction of the magnetic field 26 is parallel to a plane of the loop antenna. Therefore, the electric current generated in the loop antenna becomes substantially zero when the RFID tag 27 is positioned at Xa or Xc, thereby making it impossible for the reader/writer 24 and the RFID tag 27 to communicate with each other. Such a position at which no communication can be performed is a “null point”.

FIG. 3B is a diagram illustrating an electric current generated in the bar antenna illustrated in FIG. 2B. In the case where the RFID tag 27 having mounted therein the bar antenna illustrated in FIG. 2B is positioned at Xa or Xc, which is an end in the x-axis direction of the reader/writer 24, as illustrated in FIG. 1, the direction of the magnetic field 26 is parallel to the rotation axis direction of the bar antenna. Therefore, as illustrated in FIG. 3B, the electric current generated in the bar antenna becomes maximum when the RFID tag 27 is positioned at Xa or Xc. Note that, as illustrated in FIG. 1, since the direction of the magnetic field 26 at Xa is opposite from the direction of the magnetic field 26 at Xc, the electric current becomes negative current at Xc.

In contrast, in the case where the RFID tag 27 having mounted therein the bar antenna is positioned at Xb, which is the center in the x-axis direction of the reader/writer 24, as illustrated in FIG. 3B, the electric current generated in the bar antenna becomes substantially zero, thereby making it impossible for the reader/writer 24 and the RFID tag 27 to communicate with each other. In this manner, the RFID tag 27 having mounted therein the bar antenna has a position, in a communicable area where communication should be possible, at which no communication can be performed, and this position is a “null point”.

As has been described above, the electric current generated in the loop antenna becomes smaller from the center to the ends in the x-axis direction of the reader/writer 24, and there are “null points” near these ends. In contrast, the electric current generated in the bar antenna becomes greater toward the ends in the x-axis direction of the reader/writer 24, and there is a “null point” near the center in the x-axis direction. Using these antennas' characteristics, it is conceivable to use both the loop antenna and the bar antenna in order to expand the communication range.

The loop antenna and the bar antenna are arranged so as to have different rotation axes, and an electric current generated in the loop antenna and the bar antenna (hereinafter referred to as a “connected antenna”) becomes the sum of the electric currents generated in the individual antennas. FIG. 4 is a graph illustrating the electric current generated in the connected antenna. The ordinate axis and the abscissa axis of the graph illustrated in FIG. 4 are the same as those illustrated in FIGS. 3A and 3B.

As illustrated in FIG. 4, the electric current generated in the connected antenna becomes greater than that in the cases illustrated in FIGS. 3A and 3B at a position at which the electric currents in the same direction are generated in the two antennas. However, as illustrated in FIG. 4, the electric currents generated in the two antennas cancel each out at a position at which the electric currents that are in the opposite directions are generated in the individual antennas, and accordingly a “null point” at which the electric current becomes zero occurs. In this manner, a null point still occurs even in the case of combining the loop antenna and the bar antenna.

The gist of the embodiment resides in the point that the communication quality is maintained even in the case of using both the loop antenna and the bar antenna, without causing a null point to occur. Hereinafter, the configuration of an RFID tag according to some embodiments will be described.

### 1. First Embodiment

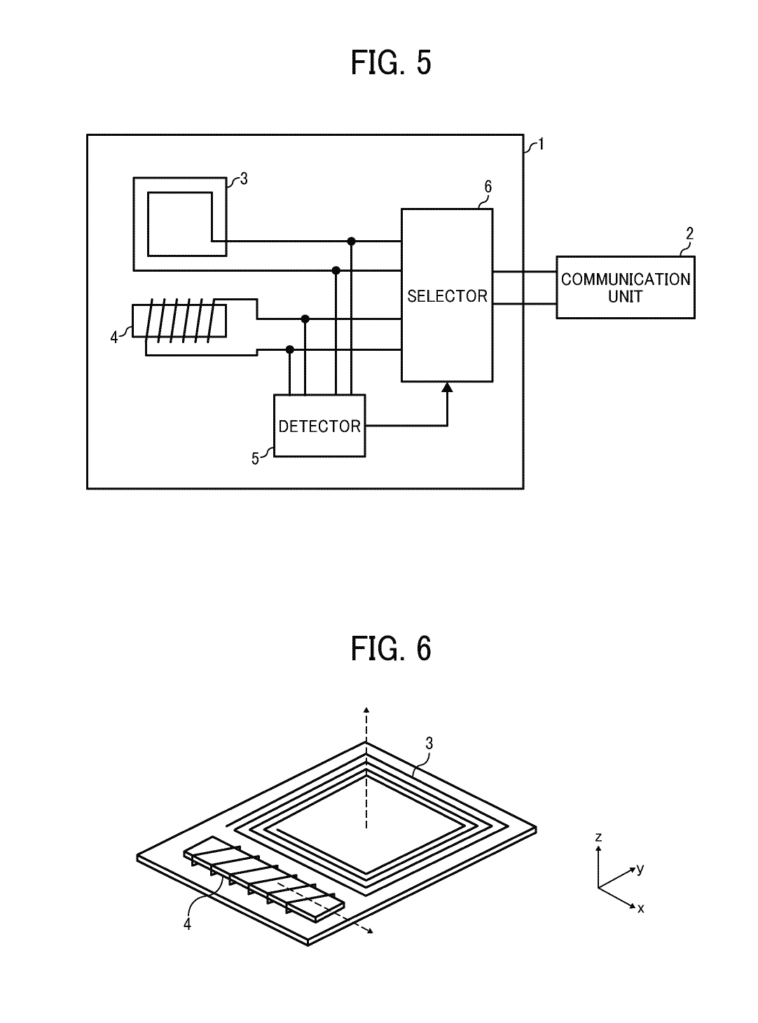

Hereinafter, a first embodiment of the present invention will be described. FIG. 5 is a diagram illustrating the configuration of an RFID tag according to the first embodiment of the present invention. As illustrated in FIG. 5, the RFID tag according to the first embodiment of the present invention includes an antenna circuit 1 and a communication unit 2. The antenna circuit 1 includes a loop antenna 3, a bar antenna 4, a detector 5, and a selector 6. The loop antenna 3 and the bar antenna 4 are antennas that have the same characteristics as those of the antennas described with reference to FIGS. 2A to 3B.

FIG. 6 is a diagram illustrating the arrangement of the loop antenna 3 and the bar antenna 4. As illustrated in FIG. 6, the loop antenna 3 is a first antenna arranged on a substrate so that the rotation axis of the loop antenna 3 is orthogonal to the substrate, and the bar antenna 4 is a second antenna arranged on the substrate so that the rotation axis of the bar antenna 4 is parallel to the substrate. That is, the rotation axis direction of the loop antenna 3 is orthogonal to the rotation axis direction of the bar antenna 4.

Note that, in the case illustrated in FIG. 6, the loop antenna 3 and the bar antenna 4 are arranged so that one side of the loop antenna 3 is parallel to the rotation axis of the bar antenna 4. However, this arrangement is not essential, and the loop antenna 3 and the bar antenna 4 may be arranged differently as long as the directions of their rotation axes with respect to the substrate are those described above. For example, the two antennas 3 and 4 may be arranged overlapping each other.

The loop antenna 3 is formed of, for example, a printed wiring pattern on the substrate. In addition, the bar antenna 4 is formed by coiling wire around a bar-shaped ferrite. Examples of the bar-shaped ferrite include a sintered ferrite, and a ferromagnetic body using alloy.

Two terminals of each of the loop antenna 3 and the bar antenna 4 are connected to the detector 5 and the selector 6. In RFID communication, when the loop antenna 3 and the bar antenna 4 receive a signal from the reader/writer 24, voltages are generated in the loop antenna 3 and the bar antenna 4.

The detector 5 detects the voltages generated in the loop antenna 3 and the bar antenna 4, and, on the basis of the voltage detection results, outputs to the selector 6 a selection signal for selecting which of the antennas is to be selected to communicate with the reader/writer 24. The detailed configuration of the detector 5 will be described later.

The selector 6 switches an antenna selected on the basis of the selection signal input from the detector 5 to be able to communicate with the reader/writer 24. The detailed configuration of the selector 6 will be described later. The communication unit 2 processes communication between the antenna selected by the selector 6 and the reader/writer 24.

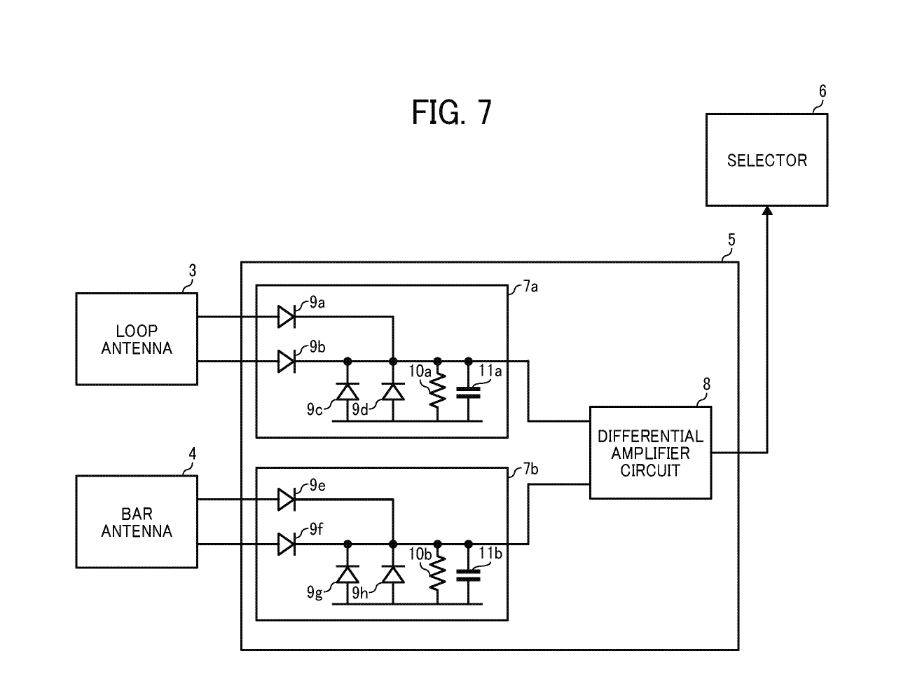

Next, the detailed configuration of the detector 5 will be described. FIG. 7 is a diagram illustrating the configuration of the detector 5. As illustrated in FIG. 7, the detector 5 includes rectifier circuits 7a and 7b, and a differential amplifier circuit 8. The rectifier circuit 7a includes diodes 9a to 9d, a resistor 10a, and a capacitor 11a. The rectifier circuit 7b includes diodes 9e to 9h, a resistor 10b, and a capacitor 11b.

The rectifier circuit 7a is connected to two ends of the loop antenna 3 through the diodes 9a and 9b. The rectifier circuit 7b is connected to two ends of the bar antenna 4 through the diodes 9e and 9f The configuration of the rectifier circuit 7a is the same as the configuration of the rectifier circuit 7b. Hereinafter, the rectifier circuits 7a and 7b may be collectively referred to as the rectifier circuit(s) 7. The rectifier circuit 7 extracts the amplitude of voltage generated across two ends of the connected antenna, and outputs the voltage amplitude to the differential amplifier circuit 8. That is, the rectifier circuit 7 functions as a signal detecting circuit that detects a signal which is a voltage amplitude.

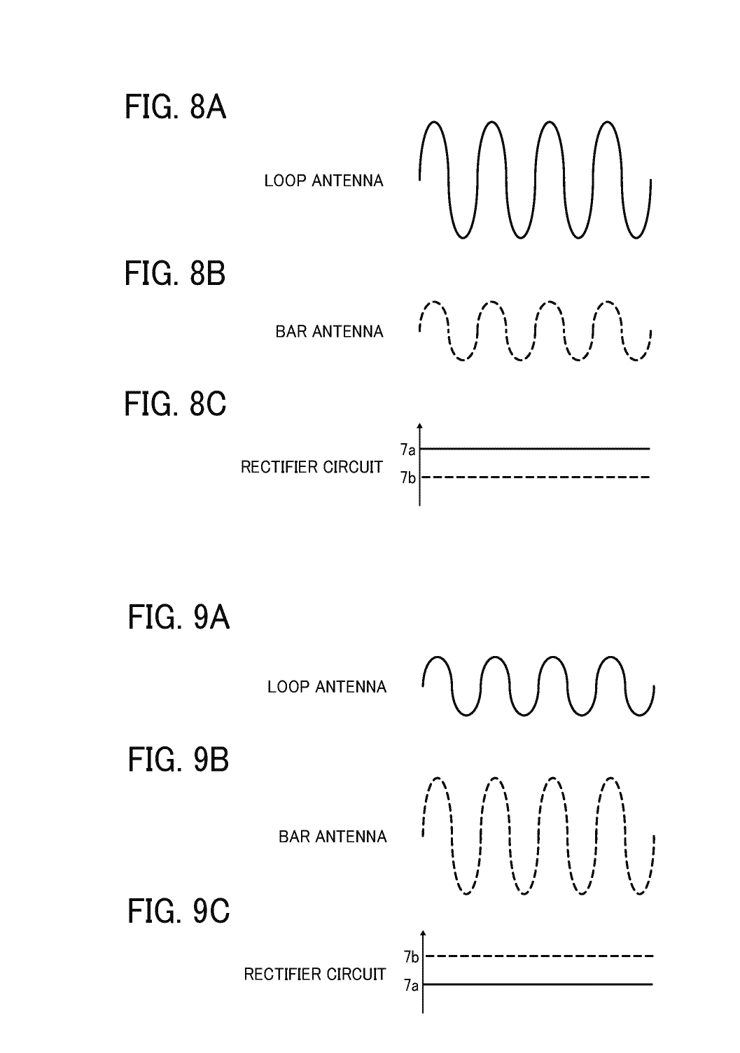

FIGS. 8A to 9C are diagrams illustrating the amplitude of voltages generated in the individual antennas, and outputs from the rectifier circuits 7a and 7b. FIGS. 8A and 9A are diagrams illustrating the amplitude of voltage in the loop antenna 3. FIGS. 8B and 9B are diagrams illustrating the amplitude of voltage in the bar antenna 4. FIGS. 8C and 9C are diagrams illustrating outputs from the rectifier circuits 7a and 7b.

As illustrated in FIGS. 8A and 8B, the amplitude of voltage in the loop antenna 3 is greater than that of the bar antenna 4. Therefore, as illustrated in FIG. 8C, an output voltage from the rectifier circuit 7a, which is indicated by a solid line, is higher than an output voltage from the rectifier circuit 7b, which is indicated by a broken line.

In contrast, as illustrated in FIGS. 9A and 9B, the amplitude of voltage in the loop antenna 3 is less than that of the bar antenna 4. Therefore, as illustrated in FIG. 9C, an output voltage from the rectifier circuit 7a, which is indicated by a solid line, is lower than an output voltage from the rectifier circuit 7b, which is indicated by a broken line.

On the basis of the output voltages input from the rectifier circuits 7a and 7b, the differential amplifier circuit 8 outputs a selection signal. For example, in the case where the output voltage from the rectifier circuit 7a is higher than the output voltage from the rectifier circuit 7b, the differential amplifier circuit 8 selects a high-level (H-level) signal as a selection signal; otherwise, the differential amplifier circuit 8 selects a low-level (L-level) signal as a selection signal. For example, in the case of the output voltages illustrated in FIG. 8C, the differential amplifier circuit 8 outputs an H-level signal as a selection signal to the selector 6. In the case of the output voltages illustrated in FIG. 9C, the differential amplifier circuit 8 outputs an L-level signal as a selection signal to the selector 6.

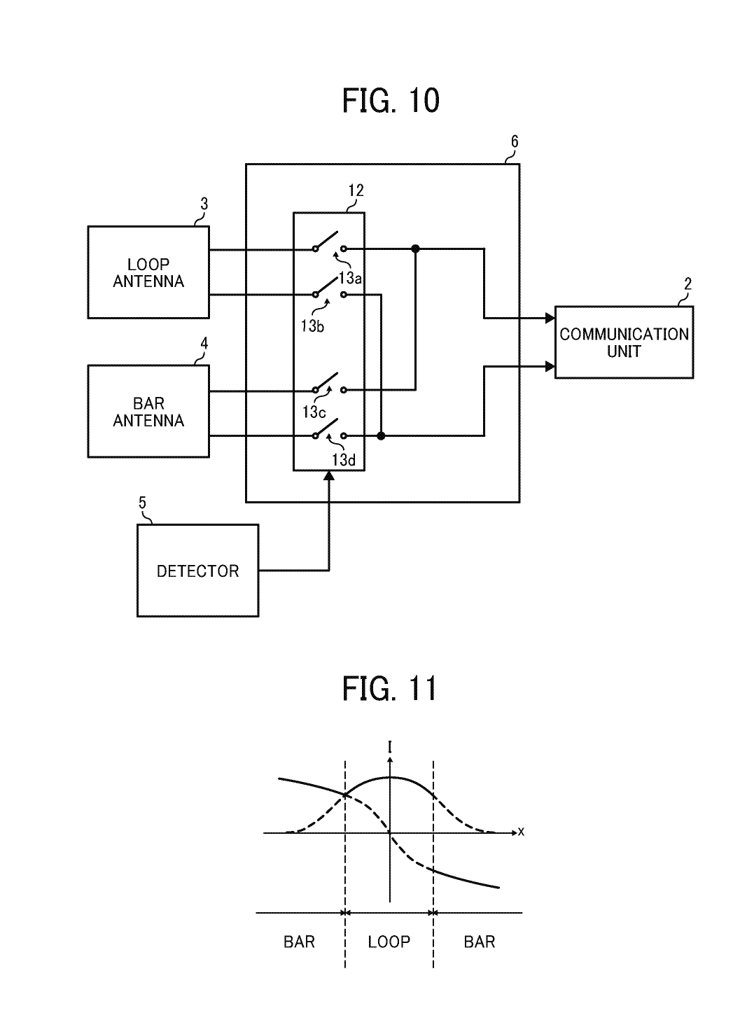

Next, the detailed configuration of the selector 6 will be described. FIG. 10 is a diagram illustrating the configuration of the selector 6. As illustrated in FIG. 10, the selector 6 includes a selection switch 12. The selection switch 12 includes switch elements 13a, 13b, 13c, and 13d, which are complementary metal oxide semiconductor (CMOS) switches, for example. In the case where the selection signal input from the detector 5 is an H-level signal, for example, the switch elements 13a and 13b are turned on, and the switch elements 13c and 13d are turned off That is, in the case where the selection signal is an H-level signal, the loop antenna 3 and the communication unit 2 are connected to each other.

In contrast, in the case where the selection signal input from the detector 5 is an L-level signal, the switch elements 13c and 13d are turned on, and the switch elements 13a and 13b are turned off That is, in the case where the selection signal is an L-level signal, the bar antenna 4 and the communication unit 2 are connected to each other.

FIG. 11 is a graph illustrating an electric current generated in the RFID tag with the configuration illustrated in FIG. 5. In the graph illustrated in FIG. 11, the abscissa axis represents an X-coordinate, and the ordinate axis represents an electric current I. At an end in the x-axis direction of the reader/writer 24 (the left end in FIG. 11), the amplitude (the absolute value of the current) of the bar antenna 4 is greater than that of the loop antenna 3. Thus, the bar antenna 4 is selected, and the result is the current indicated by a solid line in FIG. 11.

Toward the center in the x-axis direction of the reader/writer 24, the amplitude of the loop antenna 3 becomes greater than that of the bar antenna 4 at a certain position. At that position, the bar antenna 4 is switched to the loop antenna 3, and the result is the current indicated by a solid line in FIG. 11. Further, toward an end (the right end in FIG. 11) from the center in the x-axis direction of the reader/writer 24, the amplitude of the bar antenna 4 becomes greater than that of the loop antenna 3 at a certain position. At that position, the loop antenna 3 is switched to the bar antenna 4, and the result is the current indicated by a solid line in FIG. 11.

That is, the detector 5 functions as a measurer that measures a signal (voltage amplitude) generated in each of the loop antenna 3 (first antenna) and the bar antenna 4 (second antenna) in accordance with the positional relationship between the reader/writer 24, which is another device, and the wireless communication device, which is the RFID tag. In addition, the selector 6 has the function of selecting one of the first antenna and the second antenna as an antenna for communicating with another device, in accordance with the amplitude of the measured signals.

As has been described above, the wireless communication device, which is the RFID tag, including the antenna circuit 1 according to the first embodiment of the present invention, includes the loop antenna 3 arranged so that its rotation axis is orthogonal to the substrate, and the bar antenna 4 arranged so that its rotation axis is parallel to the substrate. The wireless communication device detects the amplitude of voltages generated in both antennas through the magnetic field 26 generated by the reader/writer 24, and selects, as an antenna for communicating with the reader/writer 24, an antenna whose detected voltage amplitude is greater than the other. Accordingly, a null point that occurs in the case of using each antenna by itself can be avoided, thereby improving the communication quality of an antenna for implementing a wireless communication function.

The wireless communication device according to the above-described embodiment arranges a thin loop antenna 3 formed of a printed wiring pattern on the substrate, and a relatively small and thin bar antenna 4 on the substrate so as to be in the relationship of the rotation axis directions illustrated in FIG. 6. With such a configuration, the shape of the loop antenna 3 can be suppressed to be small and thin, instead of being enlarged, and the communication quality can be improved. With the configuration according to the embodiment, the antennas can be made small and thin. Therefore, the degree of freedom in designing the wireless communication device to be mounted in a device such as a mobile terminal can be improved, and the circuit and design costs can be reduced.

### 2. Second Embodiment

Hereinafter, a second embodiment of the present invention will be described. In the first embodiment, the case in which two ends of the loop antenna 3 and the bar antenna 4 are connected to the detector 5, and voltages generated in the two antennas are detected has been described by way of example. In the second embodiment, a configuration that detects voltage is controlled to be connected to one of the antennas, and the connection is switched to sequentially detect voltages in the two antennas.

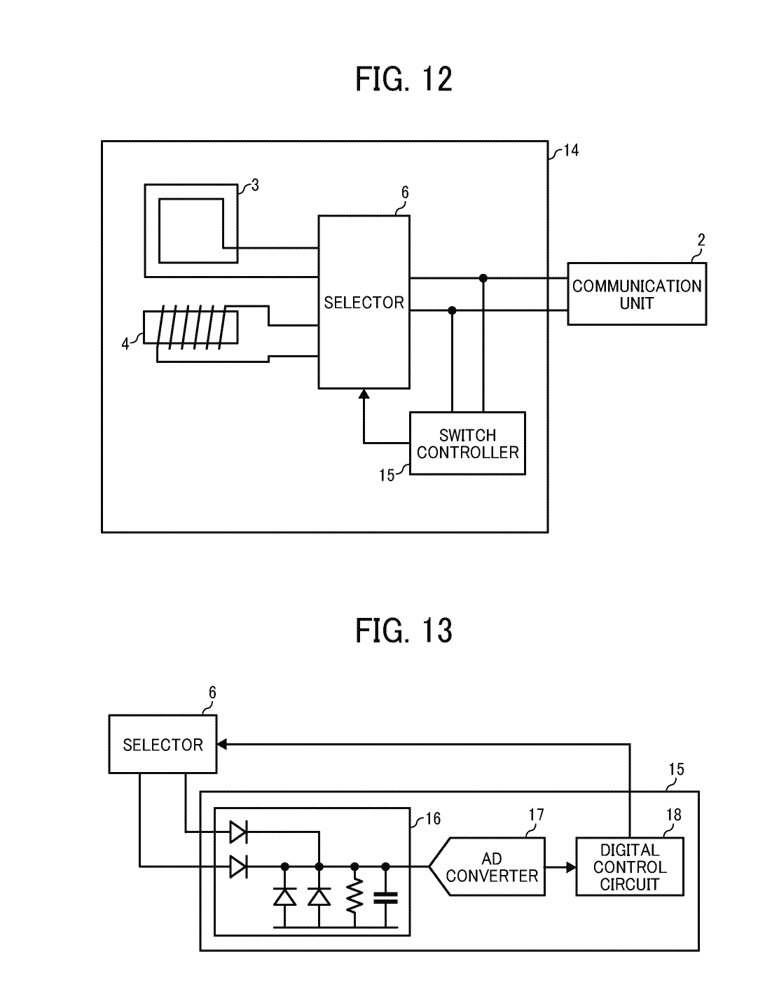

FIG. 12 is a diagram illustrating the configuration of an RFID tag according to the second embodiment of the present invention. As illustrated in FIG. 12, the RFID tag according to the second embodiment of the present invention includes an antenna circuit 14 and the communication unit 2. The antenna circuit 14 includes the loop antenna 3, the bar antenna 4, the selector 6, and a switch controller 15. The communication unit 2, the loop antenna 3, the bar antenna 4, and the selector 6 are the same as the communication unit 2, the loop antenna 3, the bar antenna 4, and the selector 6 illustrated in FIG. 5. Hereinafter, only a configuration different from the first embodiment will be described.

The switch controller 15 detects a voltage generated in an antenna selected by the selector 6, and, on the basis of the voltage detection result, outputs to the selector 6 a selection signal for selecting which of the antennas is to be selected to communicate with the reader/writer 24. Hereinafter, the detailed configuration of the switch controller 15 will be described.

FIG. 13 is a diagram illustrating the configuration of the switch controller 15. As illustrated in FIG. 13, the switch controller 15 includes a rectifier circuit 16, an analog-to-digital (AD) converter 17, and a digital control circuit 18. The rectifier circuit 16 has substantially the same configuration as that of the rectifier circuit 7.

The AD converter 17 converts one of the voltages in the loop antenna 3 and the bar antenna 4, output from the rectifier circuit 16, to a digital value, and outputs the digital value to the digital control circuit 18. In order to sequentially detect the voltages in the two antennas, the digital control circuit 18 outputs a selection signal to the selector 6. On the basis of digital values of the two antennas, sequentially input from the AD converter 17, the digital control circuit 18 outputs to the selector 6 a selection signal for selecting the antenna to communicate with the reader/writer 24.

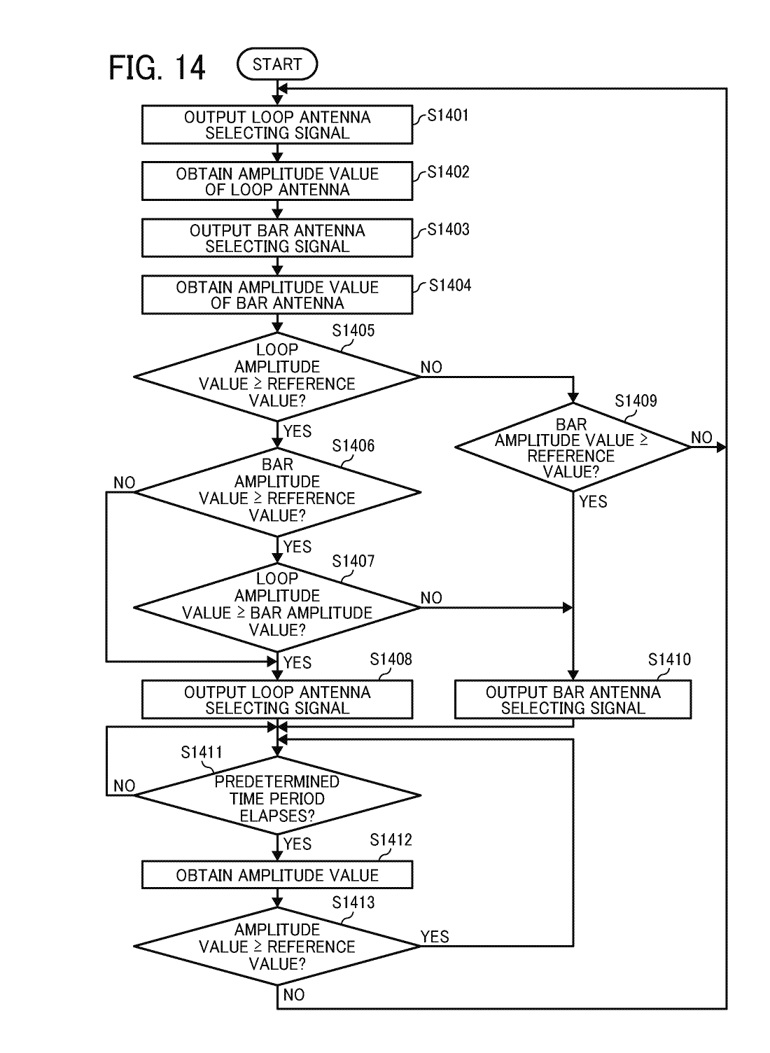

FIG. 14 is a flowchart illustrating the operation of the digital control circuit 18. As illustrated in FIG. 14, in order to first detect a voltage generated in the loop antenna 3, the digital control circuit 18 outputs a selection signal for controlling the selector 6 to select the loop antenna 3 (S1401). Having output the selection signal for selecting the loop antenna 3, the digital control circuit 18 obtains the digital value of a voltage generated in the loop antenna 3 (hereinafter referred to as a “loop amplitude value”), which is switched in response to the output selection signal to be able to communicate with the reader/writer 24 (S1402).

Next, in order to detect a voltage generated in the bar antenna 4, the digital control circuit 18 outputs a selection signal for controlling the selector 6 to select the bar antenna 4 (S1403). Having output the selection signal for selecting the bar antenna 4, the digital control circuit 18 obtains the digital value of a voltage generated in the bar antenna 4 (hereinafter referred to as a “bar amplitude value”), which is switched in response to the output selection signal to be able to communicate with the reader/writer 24 (S1404). Note that there is no restriction regarding which of the operation in S1401 and S1402 and the operation in S1403 and S1404 is performed first, and the operation in S1403 and S1404 may be executed before the operation in S1401 and S1402.

Having obtained the loop amplitude value and the bar amplitude value, the digital control circuit 18 first determines whether the obtained loop amplitude value is greater than or equal to a predetermined reference amplitude value (hereinafter referred to as a “reference value”) (S1405). In the case where the loop amplitude value is greater than or equal to the reference value (YES in S1405), the digital control circuit 18 determines whether the obtained bar amplitude value is greater than or equal to the reference value (S1406).

In the case where the bar amplitude value is greater than or equal to the reference value (YES in S1406), the digital control circuit 18 determines whether the loop amplitude value is greater than or equal to the bar amplitude value (S1407). In the case where the loop amplitude value is greater than or equal to the bar amplitude value (YES in S1408), the digital control circuit 18 outputs a selection signal for controlling the selector 6 to communicate with the reader/writer 24 using the loop antenna 3 (S1408).

In addition, in the case where the loop amplitude value is greater than or equal to the reference value (YES in S1405) and the bar amplitude value is less than the reference value (NO in S1406), the digital control circuit 18 performs the above-described operation in S1408.

In contrast, in the case where the loop amplitude value less than the reference value (NO in S1405), the digital control circuit 18 determines whether the bar amplitude value is greater than or equal to the reference value (S1409). In the case where the bar amplitude value is greater than or equal to the bar amplitude value (YES in S1409), the digital control circuit 18 outputs a selection signal for controlling the selector 6 to communicate with the reader/writer 24 using the bar antenna 4 (S1410). In contrast, in the case where the bar amplitude value is less than the reference value (NO in S1409), the digital control circuit 18 returns to the operation in S1401, and repeats the operation thereafter.

In addition, in the case where the loop amplitude value and the bar amplitude value are both greater than or equal to the reference value (YES in S1405 and YES in S1406) and the loop amplitude value is less than the bar amplitude value (NO in S1407), the digital control circuit 18 performs the above-described operation in S1410.

Because the operation in S1408 or the operation in S1410 is executed, the reader/writer 24 communicates with the RFID tag using the selected antenna. The digital control circuit 18 continuously performs communication until a predetermined time period elapses after the communication was started (NO in S1411), and, when the predetermined time period elapses (YES in S1411), obtains the amplitude value of the antenna communicating with the reader/writer 24 (S1412).

Having obtained the amplitude value, the digital control circuit 18 determines whether the obtained amplitude value is greater than or equal to the reference value (S1413). In the case where the amplitude value is greater than or equal to the reference value (YES in S1413), the digital control circuit 18 continues performing communication using the antenna communicating with the reader/writer 24. In contrast, in the case where the amplitude value is less than the reference value (NO in S1413), the digital control circuit 18 returns to the operation in S1401, and repeats the operation thereafter.

That is, the switch controller 15 functions as a measurer that measures a signal (voltage amplitude) generated in each of the loop antenna 3 (first antenna) and the bar antenna 4 (second antenna) in accordance with the positional relationship between the reader/writer 24, which is another device, and the wireless communication device, which is the RFID tag.

As has been described above, the wireless communication device, which is the RFID tag, including the antenna circuit 14 according to the second embodiment of the present invention, sequentially detects one of voltages (signals) generated in the loop antenna 3 and the bar antenna 4, by using one rectifier circuit 16. The wireless communication device selects, as an antenna for communicating with the reader/writer 24, one of the antennas on the basis of the detected amplitude values of the antennas and the reference value. Since the antenna circuit 14 according to the second embodiment can be implemented with a configuration that has a fewer rectifier circuit than the antenna circuit 1 according to the first embodiment, the same advantageous effects as those of the first embodiment can be achieved, while reducing the circuit costs.

### 3. Third Embodiment

Hereinafter, a third embodiment of the present invention will be described. In the first embodiment and the second embodiment, the case of including one antenna circuit 1 or 14, one loop antenna 3, and one bar antenna 4 has been described by way of example. An antenna circuit according to the third embodiment includes two bar antennas 4.

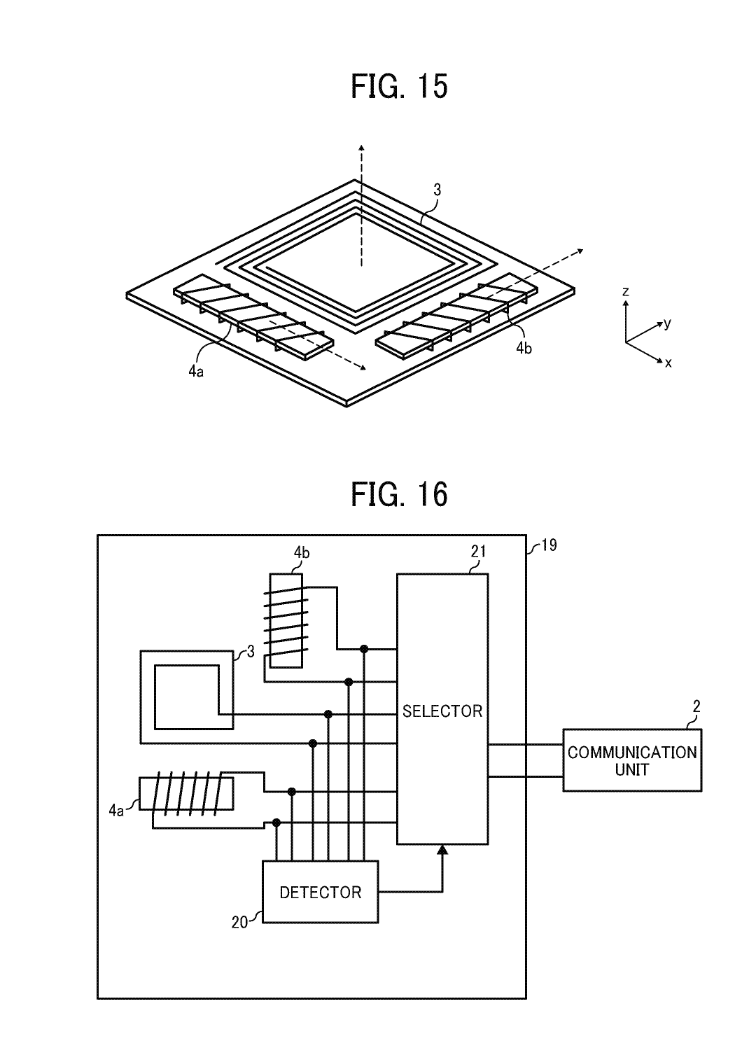

FIG. 15 is a diagram illustrating the arrangement of the loop antenna 3 and two bar antennas 4a and 4b according to the third embodiment. As illustrated in FIG. 15, like the case illustrated in FIG. 6, the loop antenna 3 is arranged so that its rotation axis is orthogonal to the substrate, and the bar antennas 4a and 4b are arranged so that their rotation axes are parallel to the substrate. In addition, as illustrated in FIG. 15, the bar antennas 4a and 4b are arranged so as to be orthogonal to each other.

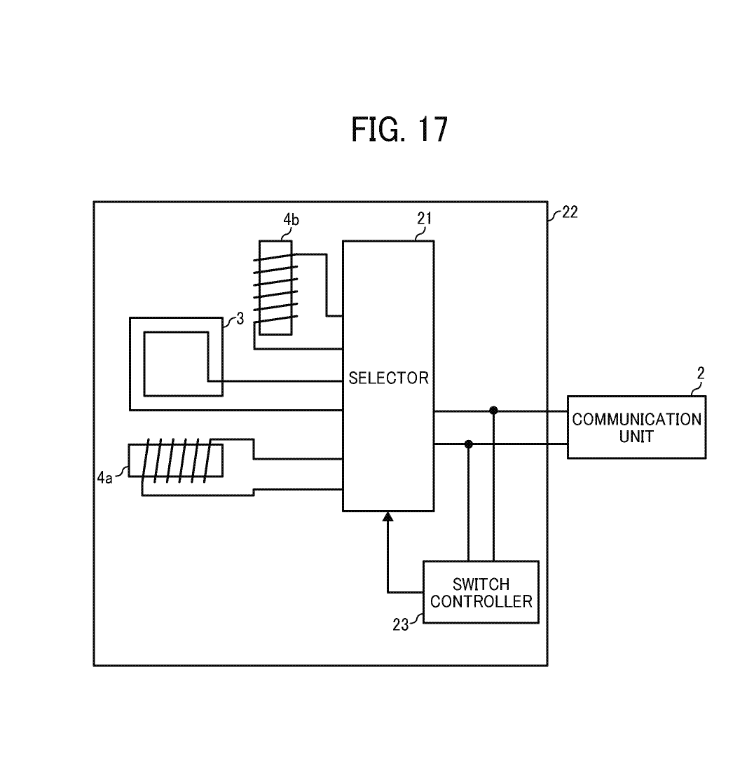

FIGS. 16 and 17 are diagrams each illustrating the arrangement of the antennas illustrated in FIG. 15, and the configuration of the RFID tag. FIG. 16 illustrates the configuration similar to the configuration according to the first embodiment, illustrated in FIG. 5, and FIG. 17 illustrates the configuration similar to the configuration according to the second embodiment, illustrated in FIG. 12.

A detector 20 included in an antenna circuit 19 illustrated in FIG. 16 detects voltages generated in the loop antenna 3 and the bar antennas 4a and 4b, and outputs to a selector 21 a selection signal for selecting an antenna whose detected voltage is maximum as an antenna for communication. The selector 21 performs switching so that the antenna selected on the basis of the selection signal input from the detector 20 becomes able to communicate with the reader/writer 24.

A switch controller 23 included in an antenna circuit 22 illustrated in FIG. 17 detects a voltage generated in an antenna selected by the selector 21, thereby sequentially detecting voltages in the three antennas. On the basis of the voltage detection results of the three antennas, the switch controller 23 outputs to the selector 21 a selection signal for selecting which of the antennas is to be selected to communicate with the reader/writer 24. The operation logic of the switch controller 23 is substantially the same as that of the case illustrated in FIG. 14.

Note that the detector 20 and the switch controller 23 each function as a measurer similar to the detector 5 according to the first embodiment and the switch controller 15 according to the second embodiment, respectively. In addition, the selector 21 has the function of selecting one of the first antenna and the second antennas as an antenna for communicating with another device, like the selector 6 according to the first embodiment and the second embodiment.

With such a configuration, an antenna whose amplitude value is the greatest among the three antennas can be used as an antenna for communicating with the reader/writer 24. Accordingly, the communication range can be expanded in both the x-axis and the y-axis directions. According to the configuration illustrated in FIG. 17, the circuit dimensions can be made smaller than the configuration illustrated in FIG. 16.

In the wireless communication device according to the first to third embodiments, the case in which the loop antenna 3 and the bar antenna(s) 4 formed of printed wiring patterns are arranged on the substrate as illustrated in FIG. 6 or FIG. 15 has been described by way of example. By arranging the above-mentioned loop antenna 3 and bar antenna(s) 4, the antennas can be made small and thin, as has been described in the first embodiment. However, it is not essential to use the loop antenna 3 and the bar antenna(s) 4. For example, the first antenna, which has been described by way of example as the loop antenna 3 formed of a printed wiring pattern, may be any antenna as long as it is an antenna arranged on the substrate so that its rotation axis is orthogonal to the substrate. In addition, for example, the second antenna, which has been described by way of example as the bar antenna(s) 4, may be any antenna as long as it is an antenna that is a loop(s) of coiled wire and that is arranged on the substrate so that its rotation axis is parallel to the substrate.

The wireless communication device according to the first to third embodiments has been described using, for example, the case of comparing the amplitude values of the individual antennas and selecting one antenna whose amplitude value is maximum as an antenna for communicating with the reader/writer 24. Alternatively, in addition to the amplitude values of the individual antennas, the amplitude value in the case where a plurality of antennas are connected to the communication unit 2 may be compared.

In the case where a plurality of antennas are connected to the communication unit 2, the electric current generated is the sum of electric currents generated in the individual antennas. Depending on the positional relationship between the RFID tag and the reader/writer 24, the amplitude value in the case where the plurality of antennas are connected to the communication unit 2 may become maximum. With such a configuration, depending on the positional relationship between the RFID tag and the reader/writer 24, the communication quality can be maintained, compared with the case of performing communication with the reader/writer 24 by using any one of the antennas, even when the RFID tag and the reader/writer 24 are distant from each other.

In this case, the selector 6 or 21 has the function of selecting, as an antenna for communicating with another device, one of the first antenna and the second antenna(s), or an antenna having a plurality of antennas including the first antenna and the second antenna, in accordance with the amplitude of signals measured by the detector 5 or 20 and the switch controller 15 or 23 functioning as a measurer.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A wireless communication device that communicates wirelessly with other device, comprising:
a first antenna disposed on a substrate so as to have a rotation axis orthogonal to the substrate, the first antenna having one or more loops of coiled wire;
a second antenna disposed on the substrate so as to have a rotation axis parallel to the substrate, the second antenna having one or more loops of coiled wire;
a measurer that measures signals respectively generated in the first antenna and the second antenna, in accordance with a positional relationship between the other device and the wireless communication device; and
a selector that selects one of the first antenna and the second antenna as an antenna for communicating with the other device, in accordance with amplitude of the measured signals.

2. The wireless communication device according to claim 1, wherein the first antenna is formed of a printed wiring pattern on the substrate.

3. The wireless communication device according to claim 1, wherein the second antenna is a bar antenna that is wire coiled around a magnetic body.

4. The wireless communication device according to claim 1, wherein
the second antenna includes two second antennas, and
the two second antennas are arranged so that their rotation axes are orthogonal to each other.

5. The wireless communication device according to claim 1, wherein the measurer includes a plurality of signal detecting circuits that respectively detect the signals respectively generated in the first antenna and the second antenna, and the measurer measures the signals respectively detected by the plurality of signal detecting circuits.

6. The wireless communication device according to claim 1, wherein
the measurer includes a signal detecting circuit that detects one of the signals respectively generated in the first antenna and the second antenna, and
the measurer controls the selector to sequentially select the first antenna and the second antenna, and, using the signal detecting circuit, sequentially detects and measures the signals respectively generated in the selected first antenna and second antenna.

7. The wireless communication device according to claim 1, wherein the selector selects, as an antenna for communicating with the other device, an antenna to which at least one of the first antenna and the second antenna is connected, in accordance with the amplitude of the measured signals.

8. The wireless communication device according to claim 1, wherein the measurer includes at least one of a detector and a switch controller.

9. A mobile terminal comprising the wireless communication device according to claim 1.

10. The mobile terminal according to claim 9, wherein the wireless communication device is a radio-frequency identifier (RFID) tag.
